(19) United States
(12) Patent Application Publication
(10) Pub. No.: US 2017/0261238 A1
(43) Pub. Date: Sep. 14, 2017

(54) VEHICLE AND STORAGE LNG SYSTEMS

(71) Applicant: Global Cooling, Inc., Athens, OH (US)

(72) Inventor: David M. Berchowitz, Athens, OH (US)

(21) Appl. No.: 15/609,376

(22) Filed: May 31, 2017

Related U.S. Application Data
(62) Division of application No. 13/927,538, filed on Jun. 26, 2013.
(60) Provisional application No. 61/674,588, filed on Jul. 23, 2012.

(51) Int. Cl. F25B 9/14

(52) U.S. Cl. CPC F25B 9/14; F17C 2270/0178; F17C 2201/056; F17C 2201/058; F17C 2203/0308; F17C 2203/0391; F17C 2223/0161; F17C 2225/0161; F17C 2250/032; F17C 2250/043; F17C 2250/0439; F17C 2250/0626; F17C 2265/034; F17C 2265/066; F17C 2201/0157

(57) ABSTRACT

LNG, for use as a motor vehicle fuel, is stored in a manner that does not require massive tanks, eliminates evaporative loss and reduces refrigeration energy consumption. A Stirling cryocooler extends through a wall of a highly insulated, relatively low pressure container to its cold end located in the vapor phase above the liquid surface. The pressure or temperature of the LNG is sensed and applied to a feedback control that modulates the heat transfer rate of the Stirling cryocooler so that LNG vapor is liquefied at a rate to maintain a desired pressure and temperature within the container. Maintaining a superatmospheric pressure in the container reduces the energy consumption required for re-liquefaction of the LNG vapor. The apparatus is also usable for liquefaction of natural gas for refueling vehicles from the ubiquitous consumer level domestic gas distribution system.

### CROSS-REFERENCES TO RELATED APPLICATIONS

This application is a division of application Ser. No. 13/927,538 filed Jun. 26, 2013 which claims the benefit of U.S. Provisional Application No. 61/674,588 filed Jul. 23, 2012 The above prior applications are hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention generally relates to providing a practical means for using as a motor vehicle fuel a liquefied combustible gas, such as liquefied natural gas (LNG) or other fuels that can be liquefied by cooling. More particularly, the invention relates to an apparatus and method for long term storage of such liquefied combustible gases in a manner that avoids fuel loss by evaporation into the atmosphere without requiring high pressure fuel containers that are associated with compressed gases and does so at a low energy cost and is practical for both a vehicle fuel container and small consumer sized fuel supply containers for refueling. The invention also relates to the liquefaction of natural gas at consumers' homes, improving the efficiency of burning the fuel and to a manner of moving the liquefied gas out of a container.

Manufacturers of gasoline powered cars are required to improve emissions and efficiency while under market pressure of ever increasing fuel prices. This has led to the development of new technologies together with their associated compromises. The hybrid vehicle reduces emissions and increases fuel efficiency by utilizing an electric motor to recover braking energy and to avoid idling losses. However, the battery is an expensive and bulky item that leads to poor space utilization. Driving performance is often compromised and the cost premium is in most cases recovered by reduced operating costs over periods of greater than 3 years. All-electric vehicles take advantage of high electric motor efficiency to obtain low operating costs. Unfortunately, battery energy storage density is poor leading to poor range. Charging is currently only practical at home and a special high current electric system is required to do this effectively. The cost premium is high leading to long payback periods that may exceed the life of the vehicle. Recent developments of the Diesel engine have allowed extraordinary gains in fuel efficiency while maintaining decent performance. However, high fuel costs offset the efficiency advantage and emission controls and amelioration systems are expensive. Compressed natural gas (CNG) vehicles enjoy low fuel costs but suffer from reduced range due to the low energy content of the fuel per unit volume and also lower power due to poor volumetric efficiency. In addition, the need for a large and heavy high-pressure fuel tank reduces trunk volume. Refueling is only possible at stations that offer CNG.

Liquefied natural gas (LNG) has been used as a fuel for motor vehicles. LNG offers the reduced cost of natural gas and the significantly lower emissions that are available from CNG. LNG is stored in highly insulated tanks at atmospheric pressure and therefore does not require the large mass that is necessary to retain a high pressure gas. LNG has been a practical option for large trucks when making a long distance run. An advantage of LNG is that it does not require the heavy high pressure tanks that are required to store CNG at pressures on the order of 3000 psi to 3600 psi. Another advantage is that LNG is more than twice as dense as CNG and therefore has more than twice the energy density. However, one problem encountered with LNG arises because LNG is stored on board vehicles and in stationery supply tanks at cryogenic temperatures in containers that are vented to the atmosphere. During the evaporation of the LNG from its container, the heat of vaporization helps maintain the low temperature required to maintain the LNG in its liquid phase. However, the evaporation also represents a fuel loss. Consequently, the use of LNG as a motor vehicle fuel is practical if the fuel is consumed in a sufficiently short time period that the fuel lost by evaporation (boil off) in that time period is small enough to keep costs reasonable. Because autos sit unused for long periods of time, during which there is evaporation loss, LNG is not practical for vehicles that are inactive for long periods of time, which is the case for passenger cars and small trucks.

LNG would become an attractive alternative to gasoline-powered vehicles and a practical fuel for cars and small trucks if it could be stored at a relatively low pressure without evaporative loss, if the equipment for doing so were relatively inexpensive to purchase and to operate and if the vehicle owner had a readily available manner of refueling the vehicle, especially from the currently commonly available domestic supply distribution system of natural gas for home heating. If these obstacles could be overcome and implemented quickly on a large scale, that would permit car owners to obtain the advantages of reduced emissions and of lower fuel and operating costs from the use of LNG.

It is, therefore, an object and purpose of the invention to provide a manner of inexpensively and rapidly overcoming these obstacles.

### BRIEF SUMMARY OF THE INVENTION

Disclosed is a system that allows vehicles to effectively use liquid natural gas (LNG) or other appropriately cooled liquefied gases even when there are substantial non-use periods where previous systems would have been subject to boil-off.

The basic concept of the invention is the combination of (1) a highly insulated LNG container that is capable of retaining the LNG under pressure, but not anywhere near the pressure required for CNG, (2) a Stirling cryocooler with its cold head extending through a container wall into the upper portion of the container which is occupied with natural gas vapor so that the vapor can condense on the cold head or a heat exchanger attached to the cold head and drip back down into the portion of the container occupied by liquid phase LNG, and (3) a negative feedback type of control system that senses the temperature or pressure within the container and modulates the rate of heat transfer by the cryocooler from the cold head to the exterior of the container in order to maintain a desired pressure within the container. Preferably, the control system is capable of selectively maintaining any of three pressure conditions. In one pressure condition, the controls system maintains a pressure which is a maximum pressure that the LNG container can safely withstand so that the LNG is confined to the container, rather than being vented to the atmosphere, which allows the cryocooler cold head to be maintained at the highest possible temperature and thereby minimize the power consumption of a prime mover that drives the cryocooler. In a second and lower pressure condition, the pressure in the LNG container is maintained at a pressure that is appropriate for propelling the LNG to the engine instead of pumping the LNG with a fuel pump. In a third and still lower pressure condition, the pressure is maintained at a pressure that allows the flow into the container of natural gas from a domestic gas supply so that the gas is condensed on the cold end or heat exchanger of the cryocooler and liquefied for refilling the container.

Another aspect of the invention is heating a small portion of LNG in a chamber mounted to the LNG container so that the heated LNG is vaporized to a pressure suitable for propelling the LNG to the engine. Yet another aspect of the invention is to include a Stirling engine as a prime mover driving the cryocooler and fueling the Stirling engine with the LNG from the LNG container. A further aspect of the invention is to position an LNG vaporizer, which vaporizes the LNG for introduction into the vehicle engine, within the air intake plenum of the vehicle engine and provide external heat exchanger fins on the surface of the vaporizer so that the heat of vaporization of the vaporizing LNG is used to cool and thereby compress the combustion supporting air that is being drawn into the vehicle engine.

### BRIEF DESCRIPTION OF THE SEVERAL VIEWS OF THE DRAWINGS

FIG. 1 is a view in perspective of an automobile on which an embodiment of the invention is installed.

FIG. 2 is a view in section of the LNG on-board storage tank illustrated in FIG. 1 with the section taken substantially along the line 2-2 of FIG. 1.

FIG. 3 is a view in section of the fuel pumping apparatus illustrated in FIG. 2 with the section taken substantially along the line 3-3 of FIG. 2.

FIG. 4 is an enlarged view in perspective of a portion of FIG. 1 illustrating the engine, the vaporizer and an air intake fuel supply system embodying the present invention.

FIG. 5 is a view in perspective of a home refueling system embodying the present invention.

FIG. 6 is a graph showing the relationship, within a sealed container of LNG, of internal pressure as a function of temperature and also the relationship of energy consumption by a Stirling cooler arrangement embodying the invention as a function of temperature.

FIG. 7 is a view in axial section of an example of a free piston Stirling cryocooler that can be used in embodiments of the invention, this example being driven by a prime mover that is an electromagnetic linear motor.

FIG. 8 is a view in axial section of an example of a free piston Stirling cryocooler that can be used in embodiments of the invention, this example being driven by a prime mover that is a Stirling cycle engine.

FIG. 9 is a diagrammatic view illustrating another example of a free piston Stirling cryocooler that can be used in embodiments of the invention, this example being driven by both an electromagnetic linear motor and a Stirling cycle engine which are intended to be used in the alternative.

FIG. 10 is a block diagram illustrating a negative feedback control system arranged to control the pressure within the LNG container.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

A first part of this invention is directed to effectively storing LNG on board cars. This is achieved by:

a. Utilizing vacuum insulation in the form of a Dewar tank and multilayer radiation shields so that heat leakage is kept to an absolute minimum. It is anticipated that the heat leak into the fuel tank can be reduced to a few Watts.

b. In order to remove all net heat transfer to the stored LNG, a small Stirling cryocooler will be used to re-liquefy the vapor from boil-off. The cryocooler will consume electrical power at a rate of about 30 W or less. When being driven, the power can be provided from the car. When the vehicle is stationary or parked, sufficient power must come from a secondary source. This can be a battery, an electrical hook up, a small solar panel, a small Stirling engine or a combination of these.

A second part of the invention is the refueling system. Since LNG terminals are not widespread and it would take time to develop such refueling infrastructure, it would be convenient to be able to use home natural gas availability. This will be achieved by:

a. Utilizing a small Stirling cryocooler to liquefy the natural gas on site. In one embodiment, this may be the same Stirling cryocooler on board the vehicle in which case the LNG is simply stored in the vehicle tank. In a second embodiment, this would be a second Stirling cryocooler of somewhat greater capacity that liquefies the natural gas into a second stationary vacuum insulated Dewar stored in a convenient location such as a home garage.

b. A special purpose coupling that attaches the car tank either to the natural gas line or to the second vacuum Dewar tank.

A third part of this invention is the engine system. This will be arranged so that the LNG heat of vaporization is used to increase the volumetric efficiency of the engine by cooling the inlet air to the engine. By this process, the engine maximum power will be increased over what is possible with CNG systems.

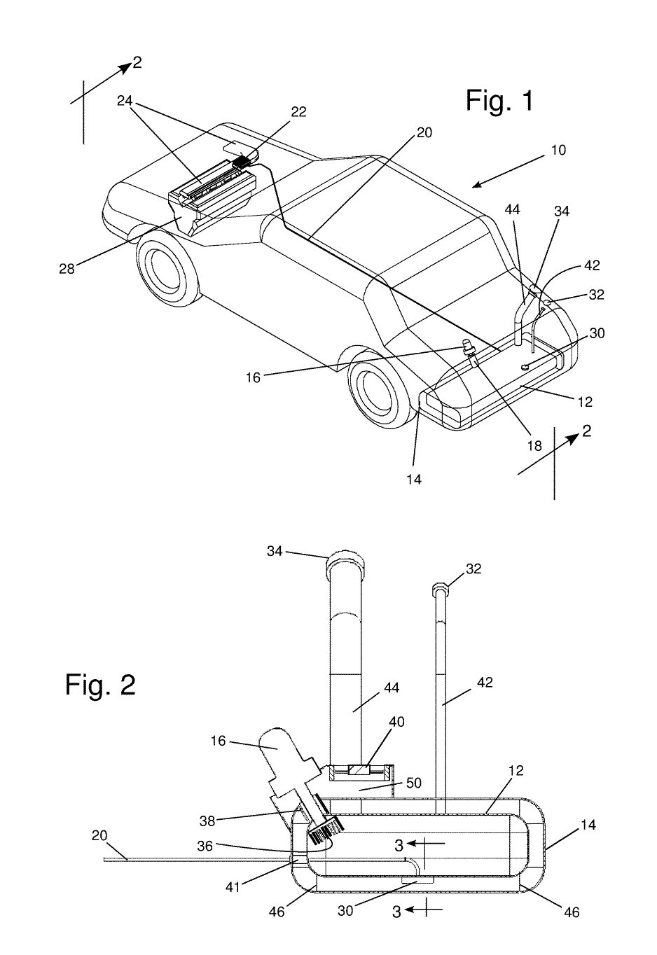

Referring to FIG. 1, an automobile 10 is shown with an LNG tank 12 surrounded by a vacuum isolating secondary shell 14. There is vacuum insulation between the tank 12 and the secondary shell 14 that would also include radiation shields and/or a proprietary insulation material like Aerogel. The design goal is to reduce the heat leak to a few Watts, say 3 Watts under typical hot ambient temperatures. Heat leaks at entrance points and supports would be reduced by use of low thermal conductivity materials. A Stirling cryocooler 16 is situated so that its cold-end penetrates the LNG tank 12 through a vacuum coupling 18. The purpose of the Stirling cryocooler is to re-liquefy boil-off gas within the tank 12. At steady state, the cooling capacity of the Stirling cryocooler would just offset the heat leak into the tank. A well-designed Stirling cryocooler would have a coefficient of performance at −162° C. of about 0.13 so the required input power for the prime mover that drives the Stirling cryocooler will be less than 25 W for this example. Improvements in the thermal insulation of the LNG tank will have strong returns on net power required by the Stirling cryocooler. Powering the Stirling cryocooler would be by an on-board battery that would be charged by the alternator on the vehicle engine, or alternatively or in combination, a solar panel placed on the roof or other convenient location on the vehicle. A small Stirling engine that utilizes the LNG fuel can also be used to drive an alternator for charging the on-board battery that powers the cryocooler or for being the prime mover driving the Stirling cooler. A duplex Stirling engine and cooler combination, in which the engine and cryocooler are integrated and use a common piston, is an attractive alternative.

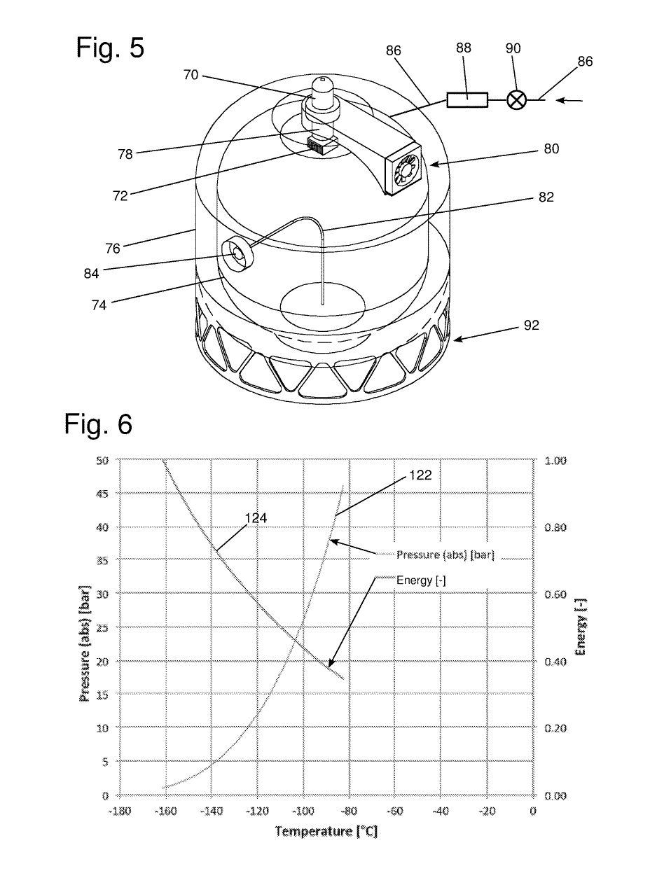

A vacuum insulated fuel line 20 carries the liquid fuel to a fuel vaporizer 22 situated in an air intake plenum 24. The vaporized or gaseous fuel is then fed to the fuel rails 26 (FIG. 4) that convey vaporized fuel to fuel injectors into the engine 28. A fuel pump 30 situated at the base of the fuel tank 12 provides fuel pressure to drive the LNG through the fuel line 20. However, an alternative means for providing fuel pressure is to operate the Stirling cryocooler 16 at a liquefaction temperature so that the saturation pressure maintained in the tank 12 is just sufficient to provide the required fuel pressure for driving the LNG fuel to the engine 28. Such control is possible with a free-piston Stirling cryocooler. A gaseous fill point 32 has a fill tube 42 leading to the tank 12 so that natural gas may be provided directly to the system from a domestic gas supply for liquefaction by the on-board Stirling cryocooler 16. Liquefaction by this method would be slow and therefore only suitable for overnight or extended idle situations. A faster method of refueling would be to provide LNG directly into the tank 12 via inlet 34. The fill inlet 34 is available for refueling from properly equipped fuelling stations or from a home refueling station as shown in FIG. 5.

FIG. 2 shows some details of the construction of the on-board vacuum insulated tank 12 and location of the Stirling cryocooler 16. A condensing heat exchanger 36 is attached to the cold-end of the cryocooler 16. The “cold end” of a Stirling cooler is the part of the cooler that is intended to accept heat and thereby cool a mass that is near or in contact with the cold end, in this case natural gas vapor. The heat is pumped by the Stirling cooler to its warm end exteriorly of the tank 12 where the heat is rejected, ordinarily into the atmosphere. The cold end preferably includes a heat exchanger surface that is designed to increase the heat transfer from the cooled mass into the cold end. For transferring heat from the gas, the heat exchanger surface is formed to have a large surface area, in this case the illustrated fins on the condensing heat exchanger 36.

The secondary shell 14 is a vacuum enclosure that surrounds the LNG tank 12. The Stirling cryocooler cold-end enters into the LNG tank 12 via a vacuum coupling 38. A low thermal conductivity penetration or vacuum coupling at 41 allows vacuum or thermally insulated fuel line 20 to enter into the LNG tank 12. The fuel line 20 takes fuel from fuel pump 30 or from just a sump in the same location if the fuel delivery pressure is controlled by the Stirling cryocooler as already described. A vacuum or thermally insulated gas line 42 provides a connection for gaseous natural gas at the natural gas inlet fill point 32. A similar vacuum or thermally insulated LNG inlet line 44 with connection inlet 34 provides a means for refueling directly from an LNG source such as a home refueling station. Low thermal conductivity supports 46 keep the LNG vacuum tank 12 separated from the secondary shell vacuum enclosure 14. Heat reject fan 40 carries the rejected heat away from the Stirling cryocooler 16 via its plenum 50.

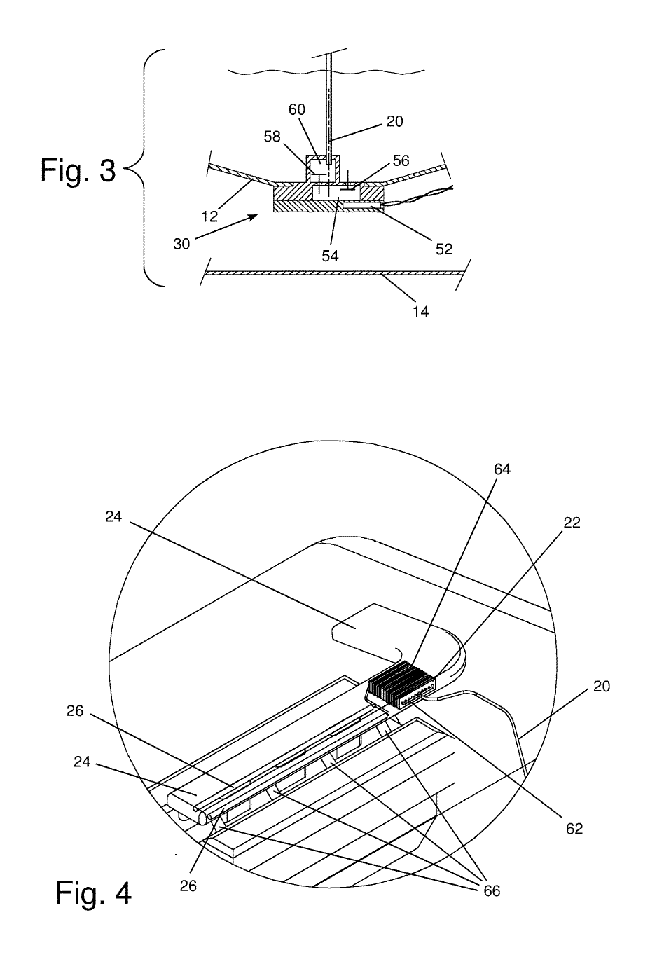

FIG. 3 shows a means to pump the LNG fuel by use of heat. This pump would be installed at the base of the fuel tank 12. By adding controlled or modulated electrical energy at the cartridge heater 52, the LNG will immediately begin to vaporize and raise the pressure in chamber 54. The chamber 54 is provided with an inlet check valve 56 and outlet check valve 58 arranged to allow fuel flow in one direction in the valve arrangement that is common with piston pumps. The pressure in the chamber 54 resulting from heating and vaporizing the LNG in the chamber 54 will close valve 56 and open valve 58 allowing mixed vapor and liquid fuel to enter the outlet plenum 60. In this manner the outlet plenum eventually achieves sufficient pressurization to deliver LNG fuel through fuel line 20. The location of the entrance to the fuel line should be set so that it is always in the liquid phase of the LNG as opposed to the vapor regime. This will ensure that the cold LNG will condense vapor resulting from heating the LNG in the fuel pump 30 so that liquid is delivered at the entrance to the fuel line 20.

Once the LNG fuel leaves the vacuum insulated tank 12, it needs to be vaporized before it is useful. A detailed view of the vaporizer 22 is shown in FIG. 4. The LNG fuel enters the vaporizer 22 through fuel line 20. The vaporizer 22 is physically located within the air intake plenum 24. The illustrated vaporizer has gas-conveying passages in pipes or conduits 62 that are interposed as part of the fuel supply conduit network between the gas supply and the engine combustion chambers. The LNG delivered to the vaporizer 22 expands and vaporizes in the vaporizer conduits 62. This vaporization both prepares the LNG for combustion and also absorbs heat from surrounding surfaces. Consequently, the vaporizer is formed as a heat exchanger and cools and therefore compresses the incoming air. For this purpose, the vaporizer has heat exchanger fins 64 on the exterior of the vaporizer. The fins 64 are longitudinally aligned along the direction of incoming air flow through air intake plenum 24 for transferring heat from incoming air through the air intake plenum 24 to the combustible gas that is vaporizing in the vaporizer. By locating the vaporizer within the air inlet plenum 24, the inlet air to the engine is cooled down by the vaporization energy of the LNG via heat exchanger 22. Since the cooled inlet air is denser than it would otherwise be, the volumetric efficiency of the engine is improved leading to better power output. Once the fuel is vaporized, it is fed to the fuel rails at 26 that feed the fuel injectors 66 that control intake of the fuel-air mixture into the engine cylinders.

A home refueling station operates in a manner similar to the vehicle system. Referring to FIG. 5, a Stirling cryocooler 70, of somewhat higher capacity than vehicle tank cryocooler 16, is placed so that a condensing heat exchanger 72, that is attached to its cold end, is exposed to the natural gas vapor in a tank 74. The Stirling cryocooler 70 is operated at a saturation temperature that results in a slight over pressure in order to provide positive pressure for refueling the vehicle. Tank 74 is vacuum insulated by the vacuum containing outer shell 76. The Stirling cryocooler 70 penetrates shell 76 by way of a vacuum coupling 78. A heat reject fan 80 carries away the heat rejected from the Stirling cryocooler at 70. LNG fuel is carried out of the tank 74 by line 82 to an LNG outlet port 84 where a vacuum insulated fuel delivery line may be attached for delivery of fuel to a vehicle. Natural gas is fed from the main domestic gas line to the tank 74 by line 86 where it is condensed on the heat exchanger 72 and drips down into the liquid phase LNG. This line 86 is equipped with a standard safety valve 88 and a shut-off valve 90. That allows an outlet from the domestic gas distribution system to provide gas that is liquefied in the tank 74 for replenishing the vehicle fuel supply. By having a stationary home refueling tank in addition to a vehicle fuel tank, natural gas can be slowly liquefied over long periods of time without requiring the presence of the vehicle. During the liquefaction of natural gas from the domestic supply, the pressure within the tank 74 would need to be maintained by the cryocooler control at a pressure that is at or near atmospheric pressure in order to allow natural gas to flow into the tank 74 because the incoming natural gas pressure is only slightly above atmospheric pressure. The entire assembly sits on a stable base 92. In the event of loss of power to the Stirling cryocooler 70, the pressure in tank 74 would rise due to boil-off of the LNG. In this event, the vaporized gas would be returned to the main gas line due to over pressurization. If this is not allowed by local ordinance or other safety rule, the gas could be blown-off through a safety vent to a place where it could be safely combusted. The gas boil-off would be extremely low due to the very low heat leak anticipated as a result of the vacuum insulation. Any damage to the vacuum insulation would signal a safety alarm so that the gas company or other provider of the natural gas can take appropriate action. Powering options for the home refueling station would be mains electric power but it could be a Stirling engine fueled by the natural gas fuel source, or a duplex configuration as already described.

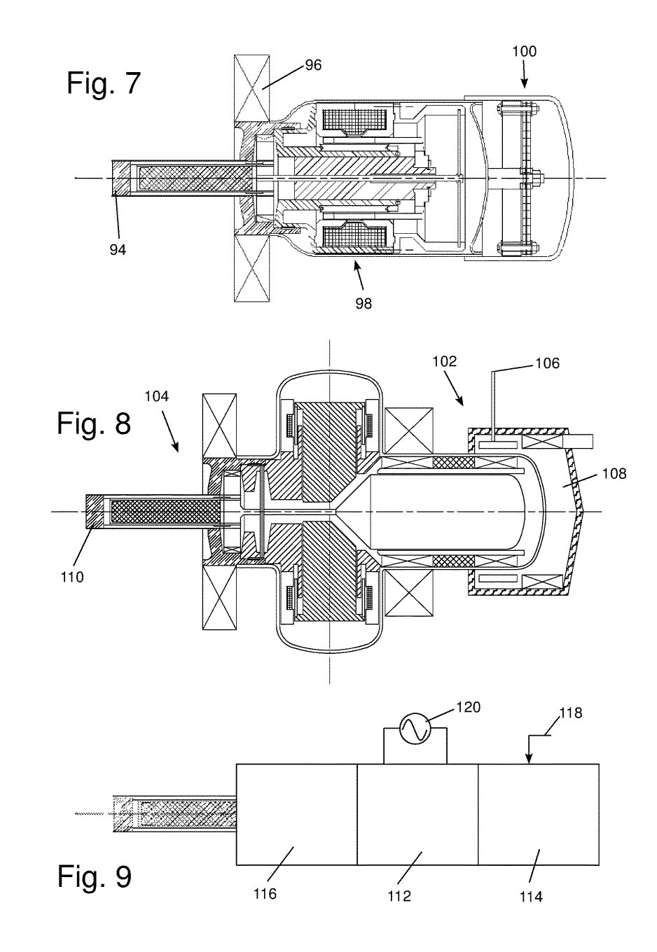

Those skilled in the free piston Stirling engine and cryocooler art are aware that there are a large and diverse variety of such Stirling machines known in the prior art. The present invention involves the use of a Stirling cryocooler but the invention is not the design of any particular Stirling cryocooler. However and by way of example, a preferred embodiment of a Stirling cryocooler is shown in FIG. 7. In this case it is a beta free-piston, balanced machine driven in reciprocation by an electromagnetic linear motor power by an alternating current. A gamma configuration of the kind disclosed in patent application U.S. Ser. No. 12/828,387 would also be satisfactory for this purpose. Key requirements are a cold head 94, a forced air reject system 96 in order to run the machine at the lowest possible reject temperature, a linear motor 98 in order to control the cooling rate so that energy consumption can be minimized during normal operation and, if direct gas liquefaction is used, to increase the cooling capacity by simply increasing the drive voltage on the linear motor 98. A vibration balancing system 100 is also essential in order to avoid unpleasant noise and vibration being transmitted to the vehicle or home refueling station.

FIG. 8 shows a Stirling engine 102 integrated with a Stirling cryocooler 104 in an arrangement in which the Stirling engine part drives the Stirling cryocooler part and is known in the prior art as the duplex configuration. LNG fuel enters the engine 102 at a fuel inlet 106 and flows into a combustor 108 where it is combusted to provide heat input to the engine 102 so the engine section will power the cryocooler 104 section. This could be an option for providing power to the Stirling cryocooler that would not require a battery or other on board power source other than the already present LNG fuel. The LNG fuel that is incoming at inlet 106 is converted directly into mechanical energy by the Stirling engine section 102 which in turn drives the cryocooler section 104 that then provides the cooling energy at the cold head 110.

FIG. 7 illustrates a Stirling cryocooler which has a linear motor as its prime mover and FIG. 8 illustrates a Stirling cryocooler which has a Stirling engine as its prime mover. It can be desirable in some situations to have available the option of driving the Stirling cryocooler with either one of two alternative power sources, electric or the available natural gas. FIG. 9 illustrates that a linear motor prime mover 112 and a Stirling engine prime mover 114 can both be drivingly linked to a Stirling cryocooler 116 for driving the latter. The Stirling engine 114 is connected to receive combustible gas 118 from the LNG fuel container for powering the Stirling cooler 116 and the linear motor 112 is connected to an AC power source 120 for also driving the Stirling cooler 116.

A free piston Stirling cryocooler, which of course operates with the Stirling cycle, is believed to be preferred for use in embodiments of the invention. However, it is believed that a pulse tube cryocooler, which also operates in accordance with the Stirling cycle, can alternatively be used. Consequently, either type of Stirling cryocooler can be used in the above described embodiments of the invention.

Though the above are embodiments of using Stirling cryocoolers to provide practical LNG fuel systems for vehicles, other embodiments are possible and are considered part of this invention. For example, the system described shows a condensing heat exchanger for re-liquefying boil-off. An alternative would be to use a thermosiphon heat transport system whereby the vacuum insulated tank walls are cooled to offset any net heat leakage. This method is employed by applicant in the use of Stirling cryocoolers to provide cooling to ultra-low temperature freezers. See U.S. Pat. Nos. 6,550,255 and 7,073,567.

From the above description of the preferred embodiment, it can be seen that the invention is an apparatus for storing a liquefied combustible gas in a thermally insulated container that is sealable from the atmosphere and capable of superatmospheric (above atmospheric) pressurization. The container can be an on-board fuel tank for a vehicle or a home storage tank for storing a liquefied combustible gas for refueling. The gas includes a liquid phase and a vapor phase located above the liquid phase with the phases separated by the surface of the liquid. A Stirling cycle cooler is mounted to the container and extends through a wall of the container to the cold end of the cooler. The cold end of the cooler is located in the vapor phase above the liquid surface and preferably has a heat transfer facilitating surface of the type commonly used on heat exchangers.

The Stirling cycle cooler is driven by a prime mover that has a variable power output. The power output of the prime mover can be varied to vary the heat transfer rate of the Stirling cycle cooler and thereby control the temperature of the cryocooler's cold end. One common type of prime mover is an electromagnetic linear motor that is mechanically linked to drive the Stirling cooler. The voltage applied to a linear motor can be varied to vary to power of the cryocooler. As known to those in the art, the stroke and power of linear motor is controlled by a control system that varies the voltage amplitude applied to the armature windings of the linear motor. Such control systems have a control input for controlling that voltage amplitude or alternatively, the armature windings themselves can be considered a combined power and control input. A Stirling engine can additionally or alternatively be mechanically linked to drive the Stirling cooler and advantageously connected to receive combustible gas from the LNG container for powering the Stirling engine.

The invention also has a temperature sensor or a pressure sensor, or both, positioned to sense temperature or pressure within the container. The sensor or sensors have an output for communicating its sensed temperature or pressure to a control system. A temperature sensor is preferably positioned in the liquid phase and a pressure sensor is preferably positioned in the vapor phase.

Embodiments of the invention use a feedback control for controlling the pressure within the container. The feedback control is designed by applying well known control principles to the following principles of the invention. The typical modern control is a digital data processor that has a stored program for operating according to its control algorithm. The control drives the Stirling cryocooler at a heat pumping rate that maintains the pressure within the container at a desired pressure. The control modulates the Stirling cooler's rate of heat transfer from the vapor phase, thereby controlling the rate of liquefaction of the LNG vapor in the container and thereby maintains the pressure within the container at a desired pressure above atmospheric pressure. As will be seen, the pressure can be controlled by sensing either the pressure or temperature within the container.

FIG. 6 illustrates the principles that are applied to control technology for the present invention. In an enclosed container of a liquefied gas, the pressure in the container is, under most conditions, the saturation vapor pressure of the gas. Saturation is when the number of molecules leaving the liquid surface (vaporizing) equals the number of molecules returning to the liquid surface (condensing). Saturation pressure is the vapor pressure when the saturation condition exists. At saturation the two phases are in equilibrium.

The saturation vapor pressure in a closed container is a function of temperature. This is illustrated in FIG. 6. The curve 122 shows the relationship of temperature to the saturation vapor pressure for LNG. The observation that is important to the present invention is that, as the saturation vapor pressure increases, the temperature increases. This means that the higher the pressure within the container, the higher is the temperature at which the saturation condition exists. The first important consequence is that the higher the pressure within the container, the higher the temperature at which a cold surface at the cold end of the Stirling cryocooler is able to liquefy vapor within the container. In order to liquefy vapor within the container, the Stirling cryocooler must lift heat through the temperature differential from the cold interior temperature within the container to the warmer ambient temperature surrounding the container. The higher the liquefaction temperature of the saturated LNG vapor, the closer the liquefaction temperature is to the ambient temperature and therefore the smaller the temperature differential through which the Stirling cryocooler must lift heat. Of course the smaller the temperature differential the less work the Stirling cryocooler must do and therefore the less energy it consumes to do it. So the second important consequence is that the higher the liquefaction temperature, the less required cooling power (energy per unit of time to pump a unit of heat from the cold end to the warm end of the cryocooler) is needed to liquefy the LNG vapor. The curve 124 of FIG. 6 illustrates the relationship of the temperature of the LNG within the container to the liquefaction energy requirement which is shown as a normalized scale.

For example, looking at FIG. 6 curve 122, at a temperature of about −165° C., the pressure within the container is approximately atmospheric pressure (approximately 1 bar absolute). Looking at FIG. 6, its curve 124 and the normalized energy scale on the right side of FIG. 6, the energy required to lift heat from −165° C. to 0° C. is approximately 1.00. However, at a temperature of about −125° C. (pressure approximately 10 bar absolute), the normalized energy requirement is approximately 0.60. In other words liquefying the LNG vapor within a container at −125° C. and 10 bar requires only approximately 60% of the energy that is required to liquefy LNG vapor at −165° C. and 50 bar. If the container is constructed to retain the LNG at 25 bar, the gas temperature at that saturation vapor pressure would be about −110° C. At that temperature and pressure, liquefying the LNG vapor within a container would require only approximately half of the energy that is required to liquefy LNG vapor at −165° C. and 50 bar.

The result of the above principles is that it is desirable to store the LNG at the highest possible safe pressure for which the container is designed in order to store the LNG at the highest possible temperature at which the saturation condition exists because this minimizes the energy consumed for re-liquefaction of the LNG by the Stirling cryocooler in the enclosed container. This result creates the opportunity for storing the LNG in a manner that avoids the need to vent, and therefore waste, some of the LNG to the atmosphere in order to maintain the LNG in a liquid phase. By containing the LNG at a superatmospheric pressure, the energy consumed by the cryocooler in the re-liquefaction of the LNG vapor can be made low enough to make the invention economically practical and attractive. The higher the saturation vapor pressure and temperature at which the LNG is maintained in the container, the less energy that is consumed by the cryocooler of embodiments of the invention. The pressure and temperature within the container is determined by the relationship of (1) the heat coming into the tank by both conduction through the container walls and the heat generated by any heater within the container to (2) the heat pumped out of the tank by the Stirling cryocooler. The Stirling cryocooler need only maintain an equilibrium between those opposite heat transfers.

It is apparent to those skilled in the art that the design of an embodiment of the invention requires typical engineering trade-offs between the container and the cryocooler. By designing the container for a higher safe maximum pressure and by designing the container with greater thermal insulation, a cryocooler with a lower cooling power capacity can be used. However, the greater the pressure capacity and thermal insulation of the container, the greater its cost and weight. A designer must choose the balance of these factors for a particular implementation of the principles of the invention.

Nonetheless, the invention offers significant advantages over the equipment used for CNG. A typical CNG container is pressurized to approximately 200 to 250 bar for storing the CNG. With the present invention, the pressure within the container can be far less than required for CNG. Consequently, a container of considerably less mass may be used than required for storing CNG. More desirably the pressure in a container embodying the present invention will be in the range of 5 bar to 20 bar and most preferably around 10 bar. As seen by the graph of FIG. 6, that means that the cryocooler can operate approximately in the range of −140° C. to −108° C. As also seen in FIG. 6, operating an embodiment of the invention at a pressure of 20 bar allows the cryocooler to consume only about half of the energy it would consume if the pressure were 50 bar. The curve 124 of FIG. 6 illustrates the dramatic reduction in energy consumption that is gained by increasing the temperature at which the LNG is stored.

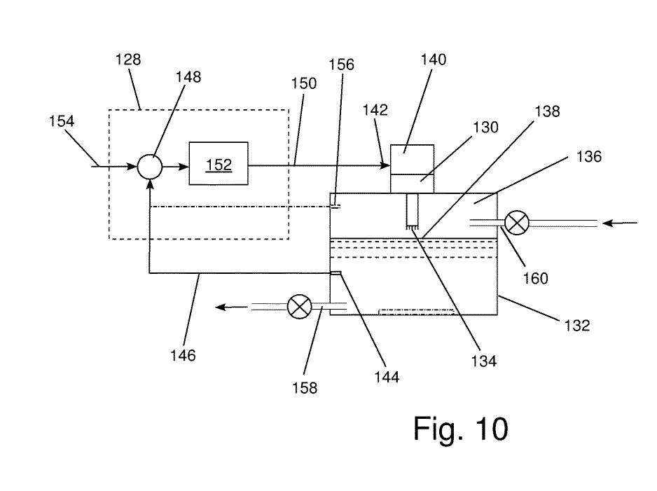

FIG. 10 illustrates a feedback control 128 for controlling the Stirling cycle cooler 130 in a manner that maintains a designer selected temperature or pressure within the highly insulated LNG container 132. The Stirling cycle cooler 130 is mounted to the container 132 and extends through a wall of the container 132 to a cold end 134 of the cooler. The cold end 134 of the cooler 130 is located in the vapor phase 136 above the liquid surface 138. The Stirling cycle cooler 130 is driven by a prime mover 140, the output power of which is controllably variable at a control input 142 for varying the heat transfer rate of the Stirling cycle cooler 130.

A temperature or pressure sensor 144 is positioned to sense the temperature and pressure within the container 132. An output 146 of the temperature or pressure sensor 144 is connected to the control's summing junction 148 which is an input of the feedback control 128 for communicating the sensed temperature or pressure to the control 128 and operating as its feedback loop. As seen from FIG. 6, temperature and pressure have a direct correlation indicated by the curve 122 so the control of either one is control of the other. Consequently, in order to control the pressure in the container, either the pressure can be directly sensed or the temperature can be sensed and used to determine the pressure. Because there is a direct correlation between temperature and pressure, a mathematical equation or a look up table can be used to convert a sensed temperature to the pressure in the container. For the same reason, the feedback control can modulate the cooler heat transfer rate to drive the temperature to a desired temperature and therefore to the desired pressure.

An output 150 of the control 128 is connected to the control input 142 of the prime mover 140. The selection of an appropriate forward transfer function 152 and the manner in which the negative feedback control 128 operates to drive the temperature or pressure within the container to a set point that is input at a set point input 154 are well known to those skilled in the art.

As an alternative, the temperature or pressure sensor may alternatively be positioned at 156 within the vapor phase 136. The arrangement of FIG. 10 is the same basic arrangement for both the on-board vehicle fuel tank of FIGS. 1 and 2 and the home refueling station illustrated in FIG. 5. An outlet 158 for liquid phase LNG leads to a vehicle engine in the case of an on-board fuel tank or to the on-board fuel tank in the case of a home refueling station. An inlet 160 for gaseous natural gas permits gas from a conventional domestic source to be liquefied in the container 132 whether the container is an on-board fuel tank or a home refueling station.

In the operation of embodiments of the invention, heat is transferred from a location in the vapor phase 136 to outside the container 132 by the Stirling cryocooler 130. This is accomplished by cooling a surface in contact with the vapor phase to a temperature below the temperature of the vapor phase. The temperature or pressure or both within the container is or are sensed and the rate of transferring heat from the vapor phase is modulated in response to the sensed temperature or pressure to maintain the pressure within the container at a desired pressure above atmospheric pressure. In order to maximize the benefit of the invention, the rate of transferring heat from the vapor phase is modulated to a rate that maintains the pressure within the container at the maximum rated safe pressure for the container. That allows the combustible gas to be stored at the warmest safe temperature and thereby minimize the power required for transferring heat from the vapor phase to outside the container.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for maintaining a liquefied combustible gas in a container that is sealed from the atmosphere, the container having a highest possible safe pressure, the gas including a liquid phase and a vapor phase above the liquid phase that are separated by a surface of the liquid phase, the method comprising:
at times storing the liquefied combustible gas, in a manner that minimizes power consumption for transferring heat from the vapor phase to outside the container, by
(a) condensing vapor phase by transferring heat from a location in the vapor phase to outside the container, the transfer including cooling a surface in contact with the vapor phase to a temperature below the temperature of the vapor phase;
(b) sensing the temperature or pressure within the container; and
(c) maintaining the pressure within the container equal to the highest possible safe pressure and maintaining the liquefied combustible gas at a temperature at which a saturation condition exists at that highest possible safe pressure in response to the sensed temperature or pressure.

2. A method in accordance with claim 1 and more particularly comprising maintaining said pressure and temperature by modulating the rate of transferring heat from the vapor phase.

3. A method in accordance with claim 2 wherein the pressure maintained within the container is in the range from above atmospheric pressure to 20 bar absolute for storing the combustible liquefied gas.

4. A method in accordance with claim 2 and further comprising
at times reducing the pressure within the container to permit the flow of natural gas from a domestic gas supply by modulating the rate of transferring heat from the vapor phase at an increased rate that maintains the pressure within the container at a lower pressure than the domestic gas supply pressure.

5. A method in accordance with claim 4 and further comprising
at times reducing the pressure within the container to permit propelling the liquefied combustible gas directly from the container to a vehicle engine without requiring a fuel pump, the pressure being reduced by modulating the rate of transferring heat from the vapor phase at an increased rate that maintains the pressure within the container at a pressure that is appropriate for propelling a liquefied combustible gas to a vehicle engine.

6. A method in accordance with claim 5 wherein the pressure is maintained in the range from above atmospheric pressure to 2 bar absolute.

7. A method in accordance with claim 1 and further comprising heating at least a portion of the gas within the container for elevating the pressure to a desired pressure.

8. An apparatus for compressing combustion-supporting air flowing into an internal combustion engine through an air intake plenum, the engine being fueled by a supply of liquefied combustible gas that is conveyed through a conduit network into engine combustion chambers, the apparatus comprising:
a combustible gas vaporizer physically located within the air intake plenum and having gas-conveying passages that are part of the conduit network, the gas-conveying passages being interposed between the gas supply and the engine combustion chambers, the vaporizer being adapted to allow expansion within the gas-conveying passages of the liquefied combustible gas, the vaporizer having heat exchanger fins on the exterior of the vaporizer, the fins being longitudinally aligned along the air flow plenum for transferring heat from incoming air through the air intake plenum to the combustible gas vaporizing in the vaporizer.
